(19) United States
(12) Patent Application Publication
(10) Pub. No.: US 2003/0140425 A1
(43) Pub. Date: Jul. 31, 2003

(54) Multi hand tool

(75) Inventor: Qiu Jian Ping, Hangzhou (CN)

Correspondence Address: Joseph J. Previto, Collard & Roe, 1077 Northern Boulevard, Roslyn, NY, 11576, US

(73) Assignee: Great Neck Saw Manufacturers, Inc.

(21) Appl. No.: 10/387,306

(22) Filed: Mar. 12, 2003

Related U.S. Application Data
(63) Continuation of application No. 09/917,305, filed on Jul. 30, 2001.

(51) Int. Cl. B25B 7/22

(52) U.S. Cl. 7/128

(57) ABSTRACT

A multi hand tool comprising a first jaw and a second jaw. The first and second jaws having convex outer surfaces. The first and second handles comprising a pair of spaced upstanding side walls and a base connecting the side wall together. The unattached edges of the side walls are in alignment and coextensive with each other. The rear ends of the jaws are attached to the handles. The second hollow handle is pivotally mounted to the second jaw. Locking mechanism includes a linkage connecting the second hollow handle with the first hollow handle and a slidable block pivotally connected to one end of the linkage with control mechanism adjacent the slidable block.

### BACKGROUND

The present invention relates to a multi hand tool and more particularly to an improved multi hand tool in which a number of tools may be incorporated in a single tool.

Multi hand tools have been in use for a number of years. They comprise a pair of movable jaws which are pivotally mounted relative to each other. Handles extend from each jaw which are preferably hollow and have auxiliary tools mounted therewithin. Some of the multi tools have means for locking the jaws into a particular position. Such tools presently in use have complicated structures, are complicated to use, and are expensive to manufacture and assemble.

### OBJECTS

The present invention overcomes these drawbacks and has for one of its objects the provisions of an improved multi hand tool.

Another object of the present invention is the provision of an improved multi hand tool which is simple to use.

Another object of the present invention is the provision of an improved multi hand tool in which the auxiliary tools are easily accessible and easily stored when not in use.

Another object of the present invention is the provision of an improved multi hand tool which may be easily locked around an article.

Another object of the present invention is the provision of an improved multi hand tool which may be easily and inexpensively manufactured and assembled.

Other and further objects of the invention will be obvious upon an understanding of the illustrative embodiment about to be described, or will be indicated in the appended claims and various advantages not referred to herein will occur to one skilled in the art upon employment of the invention in practice.

### DRAWINGS

A preferred embodiment of the invention has been chosen for purposes of illustration and description and is shown in the accompanying drawings forming a part of the specification wherein:

FIG. 1 is a side elevational view of a multi hand tool made in accordance with the present invention.

FIG. 2 is a top view thereof.

FIG. 3 is a side view partly in section showing various parts of the tool.

FIG. 4 is a side view showing the position of the parts where the jaws are in one position.

FIG. 5 is a side view partly in section shown in the position of the parts when the jaws are in another position.

FIG. 6 is a side view partly in section showing the manner of making the auxiliary tools accessible for use.

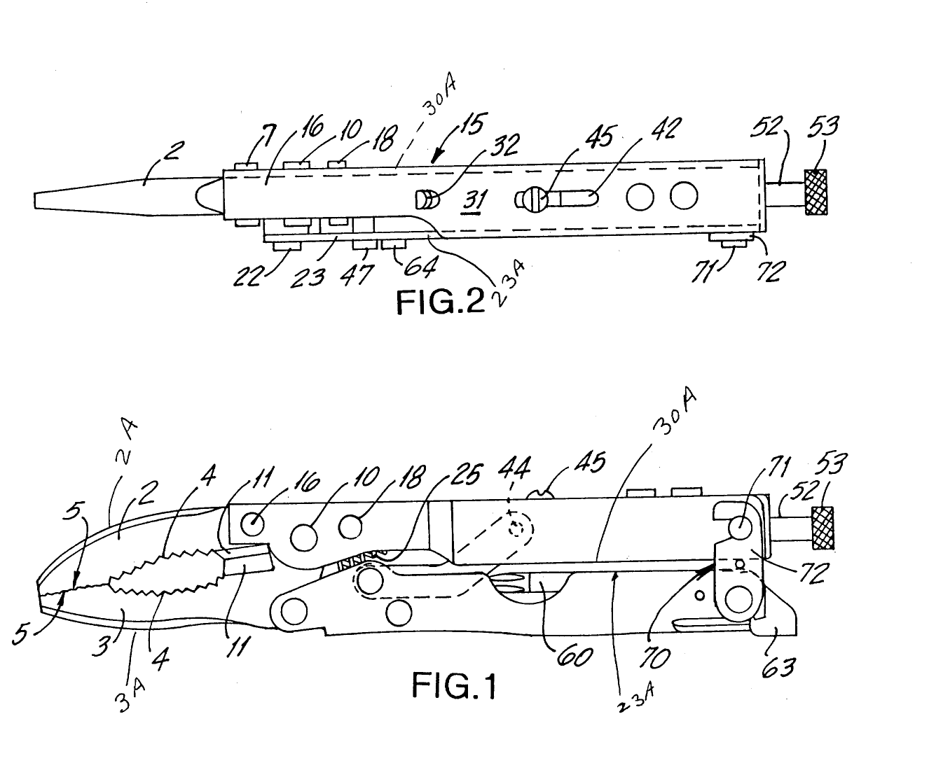

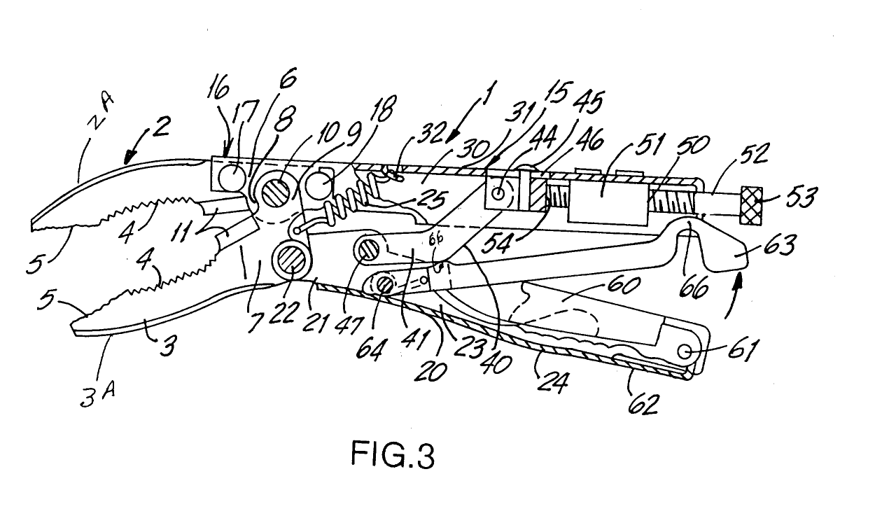

### DESCRIPTION

Referring to the drawings, the hand multi tool of the present invention comprises a first jaw 2 and a second jaw 3. Each jaw 2-3 has a curved tooth section 4, a straight tooth section 5 and a cutting edge 11. The outer edge of each jaw 2-3 is convexly curved as at 2A and 3A respectively. Each jaw 2-3 has a tail section 6 and 7, respectively, and each tail section 6-7 has a neck 8-9 extending therefrom. A pivot 10 joints the tail sections 6 and 7 to each other to permit the jaw 3 to pivot relative to the jaw 2. The first jaw 2 has a first hollow handle 15 extending therefrom which is attached at its forward end 16 to the first jaw 2 by means of fasteners 17-18. The second jaw 3 has a second hollow handle 20 pivotally mounted at its front end 21 to the tail 7 of the jaw 3 by means of pivot pin 22.

The first handle 15 has a base 31 and upstanding opposed side walls 30. The second handle 20 comprises a pair of opposed side walls 23 connected together by a base 24. The edges 30A and 23A of the side walls 30 and 23, respectively, are in alignment and coexistent with each other. A spring 25 connects the tail 7 of the second jaw 3 with the base 31 of the first handle 15 by means of a hook 32 extending from the base 31 and a pin 33 on tail 7.

A jaw locking assembly 48 is provided which comprises linkage 40 having one end 41 pivotally mounted on the second handle 20 at pivot 47 and the other end 42 pivotally mounted on a slidable lock block 43 by the means of pin 44. The lock block 43 is movable relative to the handle 15 by means of a pin 45 extending through an opening 46 in the base 31. The movement of the lock block 43 is controlled by the linkage 40. When the jaws 2-3 are opened, the lock block 43 will move towards the jaws 2-3. When jaws 2-3 are closed the lock block 43 will move away from the jaws 2-3.

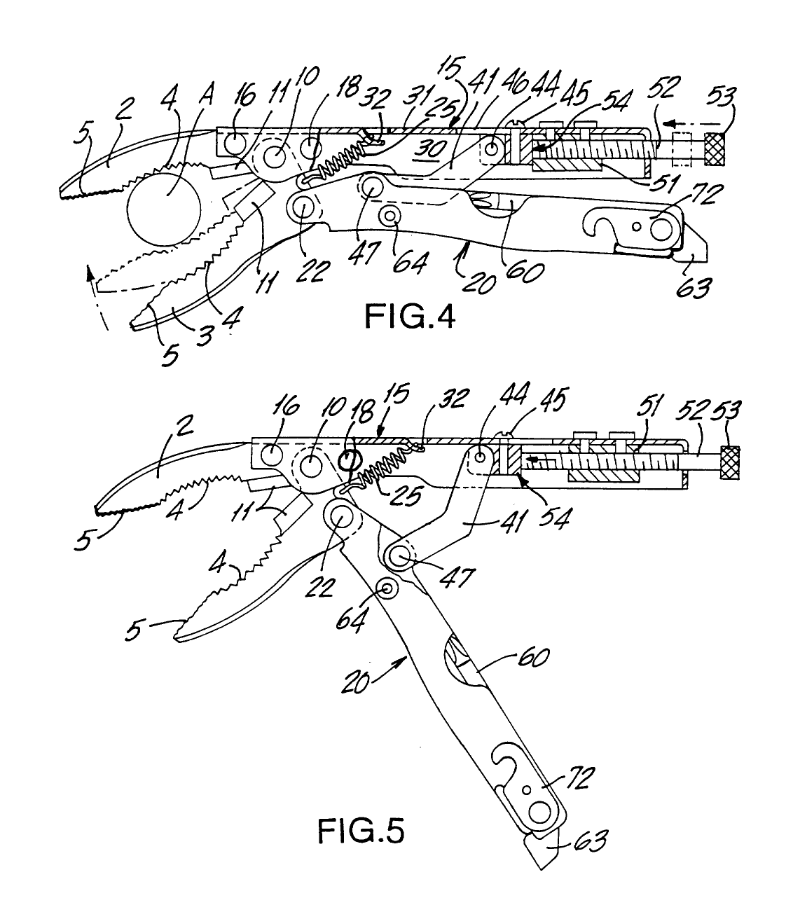

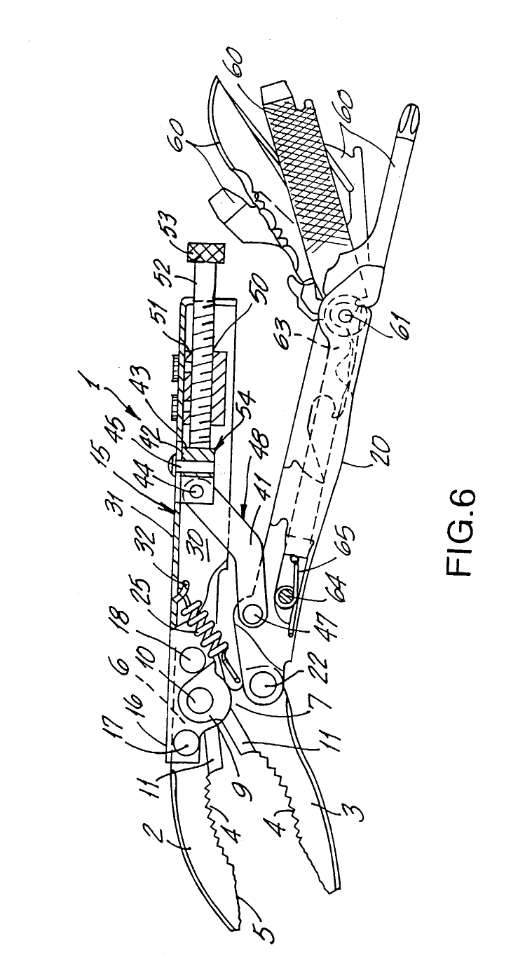

An adjusting assembly 50 is provided to permit the rearward movement of the lock block 43 to be stopped and the jaws 2-3 to be locked in place. The adjustment assembly 50 comprises a stationary block 51 mounted within the hollow handle 15 and a threaded control member 52 extending through and threadably mounted on the stationary block 51. The control member 52 has a finger knob 53 at one end and the other end 54 is adapted to bear against the lock block 43. In order to lock the jaws 2-3 in a predetermined position, they are moved from an open position, such as shown in FIG. 5 to a closed position around an article A (FIG. 4). In the open position of FIG. 5, the linkage 40 moves the lock block 43 to the forward part of the handle away from the front edge 54 of the threaded member 52. The jaws 2-3 are tightened around an article A as the handles 15-20 are moved together. This moves the lock block 43 against the edge 54 of the threaded member 52. By tightening the threaded member 52 through knob 53, the lock block 43 is moved forward thereby slowly closing and tightening the jaws 2-3 around the article A and to lock the jaws 2-3 in place. This permits the slide block 42 to be abutted by the edge 54 of the threaded member 52 at different positions thereby allowing the jaws 2-3 to lock around an article of a different size. Locking of the jaws 2-3 is completed with the movement of the handles 15-20 toward each other until pivot 47 moves past the straight line by pivot 44 and pin 22.

The hollow handle 20 has a plurality of auxiliary tools 60 pivotally mounted on pivot 61 at the outer end 62 of the hollow handle 20. These auxiliary tools 60 may be opened when they are to be used by pivoting them around the pivot 61.

In order to facilitate opening of the handles 15-20 relative to each other after the jaws 2-3 have been locked in position, a release lever 63 is mounted on a pivot pin 64 adjacent the front of the handle 20. The release lever 63 is normally within the hollow handle 20 and is held in place by means of a spring 65. When the release lever 63 is moved up its edge 66 will strike the linkage 41 and push it away from handle 20 to thereby open the jaws 2-3 slightly to facilitate further opening of the jaws 2-3 manually.

If desired, a lock latch assembly 70 may be provided comprising a knob 71 and a latch 72 in order to latch the two handles 15-20 together when the tool is in its closed position. When the tool is to be opened the release latch 72 is moved back to the open position and the release lever 62 is pushed up to initiate the separation of the two handles 15-20.

It will thus be seen that the present invention provides an improved multi hand tool which is simple to use, in which the auxiliary tools are easily accessible and easily stored when not in use, which may be easily locked around an article, and which may be easily and inexpensively manufactured and assembled.

As many and varied modifications of the subject matter of this invention will become apparent to those skilled in the art from the detailed description given hereinabove, it will be understood that the present invention is limited only as provided in the claims appended hereto.

The embodiments of the invention in which an exclusive property or privilege is claimed are defined as follows:

1. A multi hand tool comprising a first jaw and a second jaw, a first hollow handle member extending from the first jaw and a second hollow handle member extending from said second jaw, said first and second jaws having convex outer surfaces, said first and second handle members comprising a pair of spaced upstanding side walls and a base connecting the side walls together, at least a portion of the unattached edges of the side walls being in alignment and coextensive with each other, the rear ends of the jaws being attached to said handle members, said second hollow handle member being pivotally mounted to said second jaw, locking means comprising a linkage connecting the second hollow handle member with the first hollow handle member, a slidable block pivotally connected to one end of said linkage and a control mechanism adjacent said slidable block.

2. A multi hand tool as set forth in claim 1, wherein auxiliary tools are pivotally mounted in said second hollow handle member.

3. A mutli hand tool as set forth in claim 2, wherein said slidable block and control mechanism is mounted in the first hollow handle member.

4. A multi hand tool as set forth in claim 3, wherein said linkage connects said second hollow handle member with said lock block and wherein the end of said linkage is pivotally mounted to each.

5. A multi hand tool as set forth in claim 4, wherein said control mechanism comprises a threaded member extending through a control block and abutting the edge of said slidable lock block.
